(19) United States
(12) Patent Application Publication
(10) Pub. No.: US 2025/0100481 A1
(43) Pub. Date: Mar. 27, 2025

(54) ELECTRICAL JUNCTION BOX

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Takumi EJIMA, Osaka (JP); Takayuki TAKEUCHI, Mie (JP); Chiharu SAKA, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 18/830,041

(22) Filed: Sep. 10, 2024

(30) Foreign Application Priority Data
Sep. 21, 2023 (JP) 2023-156484

(51) Int. Cl. B60R 16/023

(52) U.S. Cl. CPC B60R 16/0239

(57) ABSTRACT

An electrical junction box includes: a resin case; and a component mount that protrudes from the resin case for mounting an electrical component. The component mount includes a peripheral wall portion extending along an outer peripheral surface of the electrical component. The peripheral wall portion includes a first and second wall portions disposed circumferentially adjacent to each other and extending in mutually intersecting directions. Pressure contact ribs are provided on an inner surface of at least one of the first and second wall portions, the pressure contact ribs being pressed against the outer peripheral surface of the electrical component. The first and second wall portions are circumferentially coupled to each other via a deformation-allowing wall portion, the deformation-allowing wall portion allowing outward deformation of whichever of the first and second wall portions has the pressure contact ribs provided thereon when the pressure contact ribs are pressed against the electrical component.

### CLAIM OF PRIORITY

This application claims priority of Japanese Application JP2023-156484 filed on Sep. 21, 2023, the entire contents of which is incorporated herein by reference in its entirety.

### TECHNICAL FIELD

The present disclosure relates to an electrical junction box.

### BACKGROUND ART

JP 2007-20357A discloses an electrical junction box with a component mount that protrudes from a resin case and mounts an electrical component, such as a relay. In this electrical junction box, ribs are provided on the inner surfaces of the peripheral wall portions of the component mount that extend around the outer peripheral surface of the electrical component so that the ribs are pressed against the outer peripheral surface of the electrical component. The ribs on the inner surfaces of the peripheral wall portions are pressed against the outer peripheral surface of the electrical component mounted to the component mount so as to limit the rattling of the electrical component, such as a relay, mounted to the component mount.

JP 2007-20357A is an example of related art.

### SUMMARY OF THE INVENTION

### Technical Problem

In recent years, the volumes of electrical junction boxes have been increasing due to the higher voltages used in vehicles, so that it has become necessary to improve the durability of the resin cases. Therefore, relatively hard resin, such as glass-filled resin, is more often used as the material for the resin cases. As a result, the amount of deflection of the peripheral wall portion when an electrical component is mounted to the component mount is now more limited, and the force required to insert the electrical component into the component mount becomes higher. Furthermore, there is a risk of damage to the electrical component mounted to the component mount due to vibration, etc., during use.

In view of the above, an electrical junction box is disclosed capable of limiting the increase in the force required to insert an electrical component into a component mount and reducing the risk of damage to the electrical component.

### Solution to the Problem

An electrical junction box of the present disclosure includes: a resin case; and a component mount that protrudes from the resin case for mounting an electrical component; in which the component mount includes a peripheral wall portion extending along an outer peripheral surface of the electrical component; the peripheral wall portion includes a first wall portion and a second wall portion disposed circumferentially adjacent to each other and extending in mutually intersecting directions; pressure contact ribs are provided on an inner surface of at least one of the first wall portion and the second wall portion, the pressure contact ribs being pressed against the outer peripheral surface of the electrical component; and the first wall portion and the second wall portion are circumferentially coupled to each other via a deformation-allowing wall portion, the deformation-allowing wall portion allowing outward deformation of whichever of the first wall portion and the second wall portion has the pressure contact ribs provided thereon when the pressure contact ribs are pressed against the electrical component.

### Advantageous Effects of the Invention

The electrical junction box according to the present disclosure is capable of limiting the increase in the force required to insert an electrical component into a component mount and reducing the risk of damage to the electrical component.

### BRIEF DESCRIPTION OF THE DRAWINGS

FIG. 1 is a perspective view showing electrical components mounted to component mounts of a resin case constituting an electrical junction box according to an Embodiment 1.

FIG. 2 is a perspective view showing a relay or an electrical component mounted to a relay mount or a component mount alone, with the other components of the electrical junction box of FIG. 1 omitted from the view.

FIG. 3 is a plan view of what is shown in FIG. 2.

FIG. 4 is a cross-sectional view taken along line IV-IV of FIG. 3.

FIG. 5 is a perspective view showing the relay mount shown in FIG. 2 prior to the mounting of the relay.

FIG. 6 is a plan view of what is shown in FIG. 5.

FIG. 7 is a perspective view showing a resistor or an electrical component mounted to a resistor mount or a component mount in the electrical junction box shown in FIG. 1.

FIG. 8 is a plan view of what is shown in FIG. 7.

FIG. 9 is a perspective view showing the resistor mount shown in FIG. 8 prior to the mounting of the resistor.

FIG. 10 is a perspective view corresponding to FIG. 6 and shows a resin case constituting an electrical junction box according to an Embodiment 2, showing a relay mount or a component mount alone, with the other components of the electrical junction box omitted from the view.

FIG. 11 is a perspective view corresponding to FIG. 9 and shows the resin case constituting the electrical junction box according to Embodiment 2, showing a resistor mount or a component mount alone, with the other components of the electrical junction box omitted from the view.

### EMBODIMENTS OF THE INVENTION

### Description of Embodiments of the Present Disclosure

First, embodiments of the present disclosure will be listed and described.

An electrical junction box of the present disclosure includes:

(1) a resin case; and a component mount that protrudes from the resin case for mounting an electrical component; in which the component mount includes a peripheral wall portion extending along an outer peripheral surface of the electrical component; the peripheral wall portion includes a first wall portion and a second wall portion disposed circumferentially adjacent to each other and extending in mutually intersecting directions; pressure contact ribs are provided on an inner surface of at least one of the first wall portion and the second wall portion, the pressure contact ribs being pressed against the outer peripheral surface of the electrical component; and the first wall portion and the second wall portion are circumferentially coupled to each other via a deformation-allowing wall portion, the deformation-allowing wall portion allowing outward deformation of whichever of the first wall portion and the second wall portion has the pressure contact ribs provided thereon when the pressure contact ribs are pressed against the electrical component.

According to the electrical junction box of the present disclosure, in the component mount for mounting an electrical component, the peripheral wall portion of the component mount that surrounds the outer peripheral surface of the electrical component includes a first wall portion and a second wall portion extending in mutually intersecting directions, and pressure contact ribs are provided on an inner surface of at least one of the first wall portion and the second wall portion, the pressure contact ribs being pressed against the outer peripheral surface of the electrical component. Furthermore, as the first wall portion and the second wall portion are circumferentially coupled to each other via a deformation-allowing wall portion, the deformation-allowing wall portion allows outward deformation of the at least one of the first wall portion and the second wall portion provided with the pressure contact ribs when the pressure contact ribs provided on the wall portion(s) are pressed against the electrical component. Therefore, it is possible to advantageously reduce the limitation of the outward deformation of the wall portion(s) provided with the pressure ribs caused by other intersecting wall portions that are circumferentially coupled together and extended. As a result, even if the resin case is formed of relatively hard resin, such as glass-filled resin, it is possible to limit the increase in the force required to insert the electrical component into the component mount and reduce the risk of damage to the electrical component due to vibration, etc., during use.

Any structure may be used for the deformation-allowing wall portion as long as it can reduce the limitation of the deformation of the wall portions provided with the pressure contact ribs by other wall portions when the ribs are pressed against the electrical component. For example, it may be formed with a wall portion that allows deformation, or the deformation-allowing wall portion may be formed of a highly flexible material to allow deformation.

(2) In (1) above, it is preferable that the pressure contact ribs be provided on the inner surfaces of the first wall portion and the second wall portion. As the pressure contact ribs are provided on the inner surfaces of the first wall portion and the second wall portion, it is possible to limit the rattling of the electrical component even more stably. Moreover, as the deformation-allowing wall portion circumferentially couples the first wall portion and the second wall portion together, it is possible to limit the increase in the insertion force even if a larger number of pressure contact ribs are used.

(3) In (1) or (2) above, it is preferable that the deformation-allowing wall portion be connected to circumferentially opposing edges of the first wall portion and the second wall portion, and have a shape that extends circumferentially around a virtual intersection between the first wall portion and the second wall portion. The deformation-allowing wall portion has a shape that extends circumferentially around a virtual intersection between the first wall portion and the second wall portion and is connected to the circumferentially opposing edges of the first wall portion and the second wall portion. In this way, opposing surfaces of a corner of the electrical component and the deformation-allowing wall portion creates a larger space therebetween than an opposing surface of the first wall portion or the second wall portion and the outer peripheral surface of the electrical component. Due to this space, it is possible to reliably reduce the limitation of the deformation of one of the first wall portion and the second wall portion by the other of the first wall portion and the second wall portion when the pressure contact ribs are pressed against the electrical component in comparison with the case in which the first wall portion and the second wall portion are directly connected at the virtual intersection therebetween. In this aspect, particularly, due to the ingenious shape of the deformation allowing wall portion, the first wall portion and the second wall portion are allowed to outwardly deform independently of each other.

(4) In (3) above, it is preferable that the deformation-allowing wall portion have an arc shape with a center thereof at the virtual intersection, the arc shape connecting the circumferentially opposing edges of the first wall portion and the second wall portion. As the deformation-allowing wall portion has an arc shape with a center thereof at the virtual intersection, the arc shape connecting the circumferentially opposing edges of the first wall portion and the second wall portion, the deformation-allowing wall portion has a generally smooth shape to reduce the risk of localized concentration of a stress, so that it is possible to tolerate (i.e., absorb) outward deformation of the wall portions on which the pressure contact ribs are provided while ensuring the durability of the deformation-allowing wall portion.

(5) In any one of (1) to (4) above, it is preferable that the deformation-allowing wall portion have a curved shape connecting the circumferentially opposing edges of the first wall portion and the second wall portion. Due to the deformation-allowing wall portion, it is possible to all the more reliably reduce the limitation of the deformation of one of the first wall portion and the second wall portion by the other of the first wall portion and the second wall portion when the pressure contact ribs are pressed against the electrical component because of the circumvention of the curved shape of the deformation-allowing wall portion in comparison with the case in which the first wall portion and the second wall portion are directly connected at the virtual intersection therebetween. Furthermore, the deformation-allowing wall portion has a generally smooth shape to reduce the risk of localized concentration of a stress, so that it is possible to tolerate (i.e., absorb) outward deformation of the wall portion(s) on which the pressure contact ribs are provided while ensuring the durability of the deformation-allowing wall portion.

(6) In any one of (1) to (5) above, it is preferable that the deformation-allowing wall portion be formed of a material with greater flexibility than that of the first wall portion and the second wall portion. Advantageously, it is possible to make a deformation-allowing wall portion that allows outward deformation of the wall portion on which the pressure contact ribs are provided also by forming the deformation-allowing wall portion using a material with greater flexibility than that of the first wall portion or the second wall portion, such as by two-color molding.

### DETAILS OF EMBODIMENTS OF THE PRESENT DISCLOSURE

Specific examples of the electrical junction box of the present disclosure will be described below with reference to the drawings. Note that the present disclosure is not limited to these examples, and is indicated by the claims, and is intended to include all modifications within the meaning and range of equivalency to the claims.

### Embodiment 1

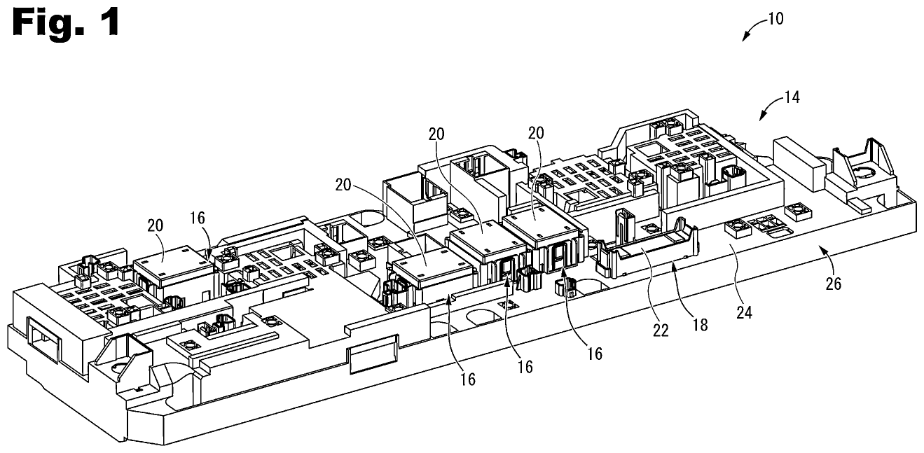

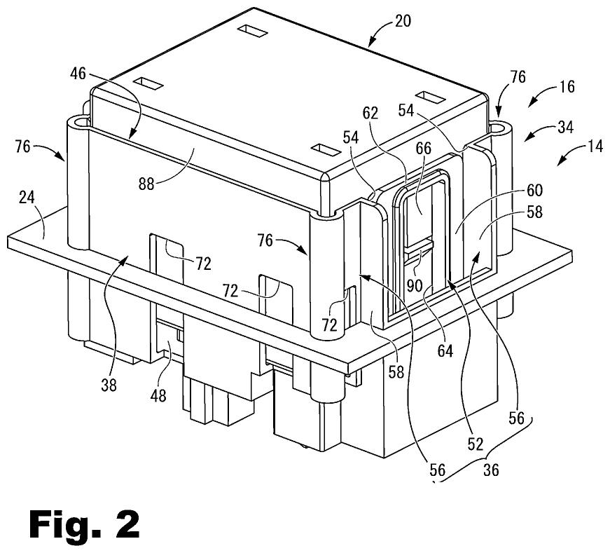

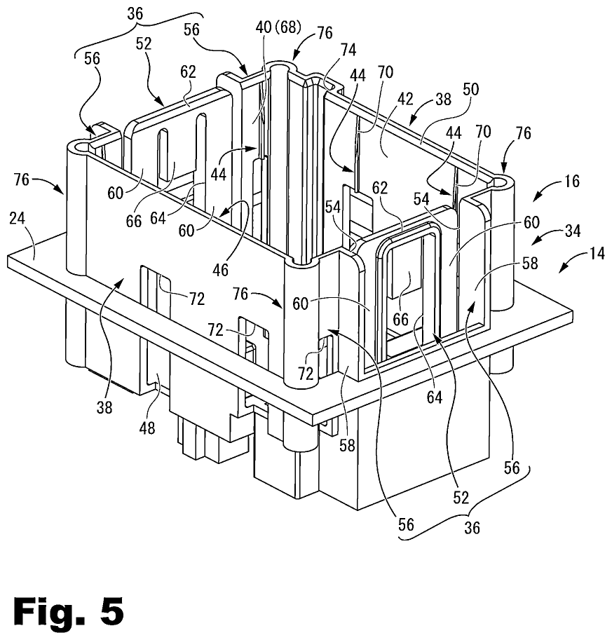

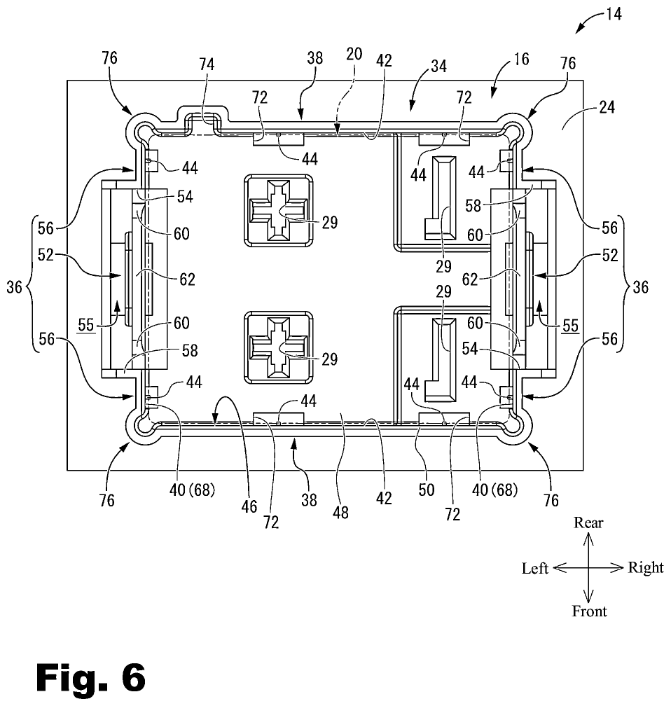

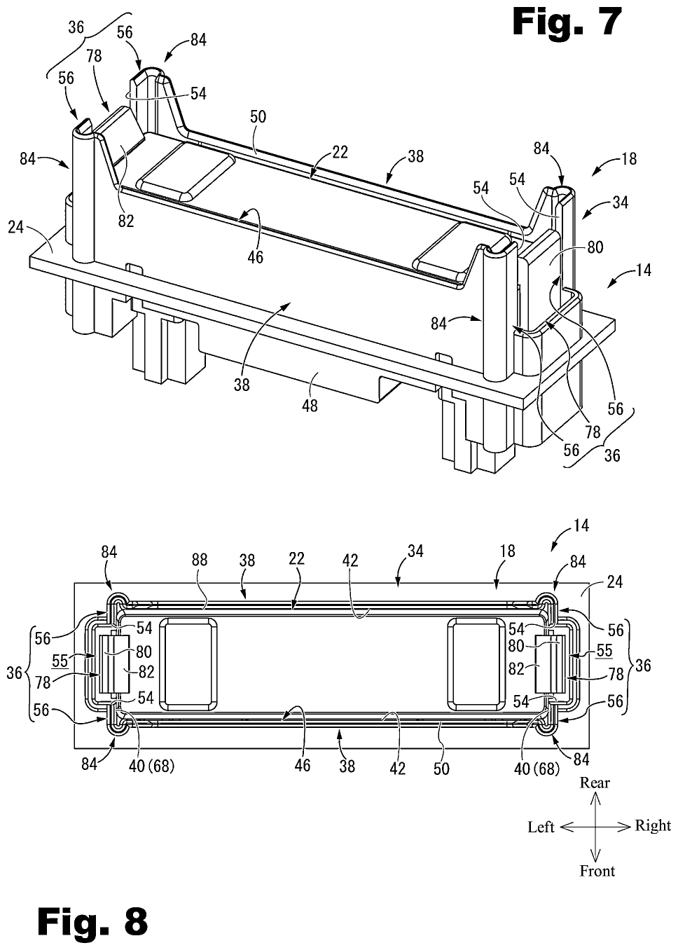

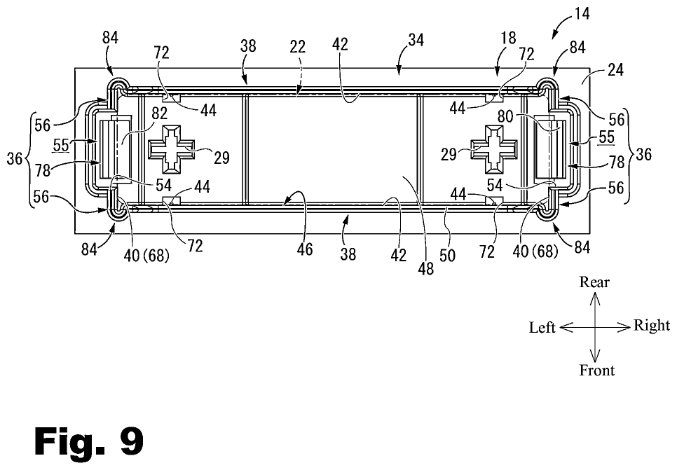

An electrical junction box 10 of an Embodiment 1 of the present disclosure will be described hereinafter with reference to FIGS. 1 to 9. The electrical junction box 10 is installed in, for example, an electric or hybrid vehicle, and electrically connects an onboard power source (not shown), for example, a battery to a load (not shown), for example, an inverter. Although the electrical junction box 10 can be held in any orientation in the vehicle, the vertical, lateral, and longitudinal directions mentioned in the following description with reference to FIGS. 2 to 9 correspond to the vertical, lateral, and longitudinal directions shown in the drawings, respectively. Furthermore, where there is a plurality of identical members, one of the identical members may be indicated by a reference symbol while such indication may be omitted for the remaining members.

### Electrical Junction Box 10

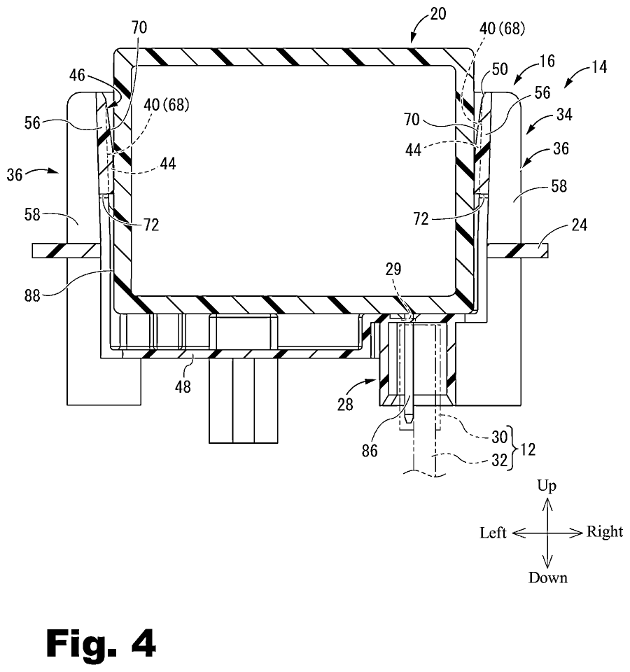

The electrical junction box 10 includes a resin case and component mounts that protrude from the resin case and mount electrical components. A current-carrying member 12 (see FIG. 4) is adapted to be conductively connected to the electrical components, and the current-carrying member 12 may be accommodated in the resin case. FIG. 1 shows a lower case 14 constituting the resin case, and the component mounts, to which the aforementioned electrical components are mounted, are provided on the lower case 14. An upper case (not shown) is fitted to the lower case 14 from above, and the upper case and the lower case 14 are secured to each other to form the resin case, in which the electrical components are adapted to be accommodated. Description of the upper case is omitted as there are no particular limitations on the structure of the upper case. In Embodiment 1, the lower case 14 has relay mounts 16 and a resistor mount 18, i.e., the component mounts, to which relays 20 and a resistor 22, i.e., the electrical components are adapted to be mounted, respectively. It should be noted that the relays 20 may include pre-charge relays. In addition, the resistor 22 may include a pre-charge resistor.

### Resin Case (Lower Case 14)

In Embodiment 1, the lower case 14 has an approximate box shape that are open generally downward, and has an approximately rectangular plate-shaped bottom wall portion 24 and a lower peripheral wall portion 26 protruding downward from the peripheral portion of the bottom wall portion 24. As shown in FIG. 4, a terminal connecting portion 28 open downward is provided in each relay mount 16 on the bottom wall portion 24 of the lower case 14, and a terminal insertion hole 29 is formed in the bottom wall portion 24 that constitutes the terminal connecting portion 28 so that terminal insertion hole 29 penetrates the bottom wall portion 24 in the thickness direction (the vertical direction). With the relay 20 mounted to the relay mount 16, the terminal 86, which will be described below, protrudes downward from the relay 20 and is inserted into the terminal insertion hole 29 so as to be located in the terminal connecting portion 28.

In the terminal connecting portion 28, a bus bar 32 is adapted to be connected to the terminal 86 via a relay terminal 30. In Embodiment 1, the current-carrying member 12, which is conductively connected to the relay 20 or an electrical component, is composed of the relay terminal 30 and the bus bar 32. The current-carrying member 12 (the relay terminal 30 and the bus bar 32) may be accommodated in the interior space of the lower case 14, which is formed in an approximate box shape, or may be provided outside the electrical junction box 10. Although not shown in the drawings, a current-carrying member 12 composed of a relay terminal 30 and a bus bar 32 may be conductively connected to a terminal protruding downward from the resistor 22 in the same manner as with the relay 20.

The relay mounts 16 and the resistor mount 18 protrude upward from the bottom wall portion 24 of the lower case 14. In Embodiment 1, a plurality of relay mounts 16 and a single resistor mount 18 are provided on the lower case 14. In particular, in Embodiment 1, the relay mounts 16 and the resistor mount 18 are integrally formed with the lower case 14. The material of the lower case 14 is not limited to any specific one as long as it is made of hard synthetic resin, such as PBT (polybutylene terephthalate) reinforced by glass fiber.

### Component Mounts (Relay Mounts 16 and Resistor Mount 18)

FIGS. 2 to 6 show a relay mount 16 and the portions of the lower case 14 surrounding the relay mount 16 alone, and FIGS. 7 to 9 show the resistor mount 18 and the portions of the lower case 14 surrounding the resistor mount 18 alone. First, the common structures of the relay mounts 16 and the resistor mount 18 will be explained hereinafter.

The component mounts (the relay mounts 16 and the resistor mount 18) have peripheral wall portions 34 extending along outer peripheral surfaces 88, which will be described below, of the electrical components (the relays 20 and the resistor 22, respectively). Each peripheral wall portion 34 includes first wall portions 36 and second wall portions 38 that are disposed circumferentially adjacent to each other and extend in mutually intersecting directions. At least either the inner surfaces 40 of the first wall portions 36 or the inner surfaces 42 of the second wall portions 38 have provided thereon pressure contact ribs 44 that protrude therefrom to be pressed against the outer surfaces 88 of the electrical components (the relays 20 and the resistor 22).

The relay mounts 16 and the resistor mount 18 are both recesses that are open upward, and have upper openings 46 formed at the upper ends of the peripheral wall portions 34 and bottom plate portions 48 extending horizontally (in a direction perpendicular to the vertical direction) at the lower end of the peripheral wall portions 34. Each bottom plate portion 48 constitutes a part of the bottom wall portion 24 of the lower case 14, and the aforementioned terminal insertion holes 29 are formed in the bottom plate portions 48. The bottom plate portions 48 are located below the bottom wall portion 24 in the lower case 14.

The relays 20 and the resistor 22 are both generally approximately rectangular in shape, and each peripheral wall portion 34 of the relay mounts 16 and the resistor mount 18 has a rectangular shape in plan view. That is, the peripheral wall portions 34 of the relay mounts 16 and the resistor mount 18 each have a pair of first walls 36 laterally spaced apart from and facing each other across a predetermined distance and a pair of second walls 38 longitudinally spaced apart from and facing each other across a predetermined distance. In Embodiment 1, the first wall portions 36 and the second wall portions 38 extend in mutually orthogonal directions. The first wall portions 36 and the second wall portions 38 extend from above the bottom wall portion 24 of the lower case 14 to below the bottom wall portion 24. In other words, each of the first wall portions 36 and the second wall portions 38 protrudes upwardly from the peripheral portion of the bottom plate portion 48 located below the bottom wall portion 24, and the upper edge of each of the first wall portions 36 and the second wall portions 38 is located above the bottom wall portion 24. The thicknesses of the first wall portions 36 and the second wall portions 38 are not limited to any specific dimensions; in Embodiment 1, the thickness dimensions of the first wall portions 36 and the second wall portions 38 are approximately the same.

### Relay Mounts 16

Each relay mount 16 (the peripheral wall portion 34) has an approximately rectangular shape with the lateral dimension thereof greater than the longitudinal dimension in plan view. The upper ends of the inner surfaces (the inner surfaces 40, 42) of the peripheral wall portion 34, thus constructed, have lead-in surfaces 50 that serve as guides when the relay 20 is mounted. As described above, the first wall portions 36 and the second wall portions 38 of each relay mount 16 extend above the bottom wall portion 24 of the lower case 14 from the peripheral portion of the bottom plate portion 48. In other words, the first wall portions 36 and the second wall portions 38 extend from the bottom wall portion 24 for a predetermined vertical dimension.

An elastic locking piece 52 is provided on each of the first wall portions 36 of the relay mount 16. More specifically, each elastic locking piece 52 is formed so as to be capable of lateral elastic deformation in the longitudinal center of the first wall portion 36. In particular, a pair of vertical slits 54 is provided in the longitudinally intermediate portion of each first wall portion 36 so as to be longitudinally spaced apart from each other, with the elastic locking piece 52 formed longitudinally between the slits 54. In Embodiment 1, the slits 54 are formed over approximately the entire vertical length of the first wall portions 36. In addition, a gap 55 is formed in the bottom wall portion 24 laterally outward from each elastic locking piece 52, so that each elastic locking piece 52 can be elastically deformed in the interior space of each gap 55 in a laterally outward direction. In other words, each gap 55 is a deformation allowing space that allows elastic deformation of the elastic locking piece 52 in the laterally outward direction.

Each first wall portion 36 is divided in the longitudinal direction by the slits 54, and each first wall portion 36 is composed of an elastic locking piece 52 at the longitudinal center thereof and divided first wall portions 56 at both longitudinal ends thereof. Each pair of slits 54 allows the elastic locking piece 52 to be elastically deformed independently of the divided first wall portions 56. In particular, the longitudinally inner end of each divided first wall portion 56 (the end on the elastic locking piece 52) is provided with a separating wall portion 58 that extends orthogonally to the divided first wall portion 56. For example, when the elastic locking pieces 52 are elastically deformed in the laterally outward direction during mounting of the relay 20 to the relay mount 16, each pair of the divided first wall portions 56 can be prevented from contacting the elastic locking piece 52 and deforming together with the elastic locking piece 52.

Each elastic locking piece 52 is composed of a pair of vertical portions 60 and a connecting portion 62 extending longitudinally to connect the top ends of the vertical portions 60. In addition, an engaging hole 64 that laterally penetrates the elastic locking piece 52 is formed in the region surrounded by the vertical portions 60 and the connecting portion 62. Each connecting portion 62 also has a flexible tongue 66 protruding within the engaging hole 64. Each tongue 66 may or may not be capable of lateral elastic deformation to a certain extent.

### Pressure Contact Ribs 44

As described above, pressure contact ribs 44 are provided on at least either the inner surfaces 40 of the first wall portions 36 or the inner surfaces 42 of the second wall portions 38. In Embodiment 1, pressure contact ribs 44 are provided on the inner surfaces 40, 42 of the first wall portions 36 and the second wall portions 38, respectively. In other words, pressure contact ribs 44 are provided on the inner surfaces 68 of the divided first wall portions 56, which constitute the first wall portions 36, and the inner surfaces 42 of the second wall portions 38. In particular, in Embodiment 1, two laterally spaced apart pressure contact ribs 44 are provided on the inner surface 42 of each second wall portion 38, and a total of eight pressure contact ribs 44 are provided on the peripheral wall portion 34. It should be noted that the longitudinal dimension between the protruding ends of the pressure contact ribs 44 facing each other in the longitudinal direction is equal to, or slightly smaller than, the longitudinal dimension of the relay 20 as the pressure contact ribs 44 are pressed against the outer peripheral surface 88 of the relay 20, which will be described later, when the relays 20 are mounted in the relay mounts 16. Moreover, the lateral dimension between the protruding ends of the pressure contact ribs 44 facing each other in the lateral direction is equal to, or slightly smaller than, the lateral dimension of the relay 20.

The pressure contact ribs 44 protrudes inward for a predetermined protruding dimension from the top ends of the inner surfaces 68, 42 of the divided first wall portions 56 and the second wall portions 38, respectively, and extend vertically for a predetermined vertical dimension. An inclined surface 70 is formed at the upper end portion of each pressure contact rib 44, and each inclined surface 70 is continuously formed from the lower end of the lead-in surface 50 provided at the upper end of the peripheral wall portion 34. The inclined surfaces 70 add to the function of the lead-in surfaces 50 to guide the relay 20 when the relay 20 is mounted to the relay mount 16.

Additionally, through-holes 72 penetrating the divided first wall portions 56 and the second wall portions 38 in the thickness directions are formed in the locations of the wall portions 56 and 38 that correspond to those of the respective pressure contact ribs 44. Each through-hole 72 is formed from the lower end of the pressure contact rib 44 to the lower end of the peripheral wall portion 34 (the lower end of the bottom plate portion 48) and has a predetermined width dimension. By providing the through-holes 72 in the peripheral wall portion 34, the relay mount 16, which includes the pressure contact ribs 44, and, by extension, the lower case 14 can be easily formed by injection molding.

It should be noted that, in Embodiment 1, a positioning recess 74 having the shape of a recessed groove is formed on the left end of the inner surface 42 of one (i.e., the rear one) of the second wall portions 38. The positioning recess 74 is formed over approximately the entire vertical length of the second wall portion 38.

### Deformation-Allowing Wall Portions 76

The first wall portions 36 and the second wall portions 38 are circumferentially connected to each other via deformation-allowing wall portions 76. In Embodiment 1, the divided first wall portions 56, which form the first wall portions 36, and the second wall portions 38 are coupled to each other by the deformation-allowing wall portions 76. In short, each deformation-allowing wall portion 76 is connected to the circumferentially opposing edges of a first wall portion 36 and a second wall portion 38, and connects the longitudinally outward end of a divided first wall portion 56 (the end of the wall portion 56 opposite where the separating wall portion 58 is provided) with the lateral end of a second wall portion 38. Each deformation-allowing wall portion 76 has a curved shape that connects the circumferentially opposing edges of a first wall portion 36 (a divided first wall portion 56) and a second wall portion 38.

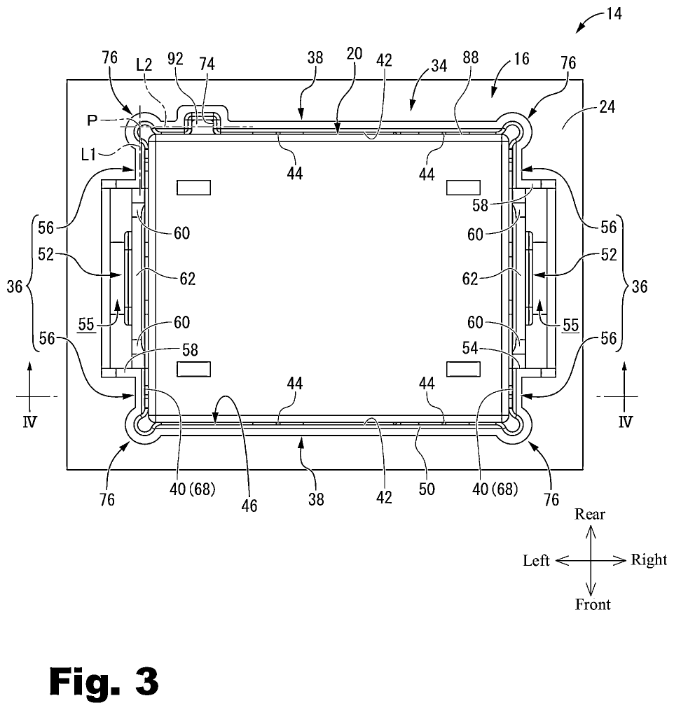

In particular, in Embodiment 1, as shown in plan view in FIG. 3, each deformation-allowing wall portion 76 has a shape that extends circumferentially around the virtual intersection P between a first wall portion 36 (a divided first wall portion 56) and a second wall portion 38. It should be noted that the virtual intersection P between a first wall portion 36 (a divided first wall portion 56) and a second wall portion 38 is the intersection in plan view between a line L1 that extends longitudinally along the center of the thickness of a first wall portion 36 (a divided first wall portion 56) and a line L2 that extends laterally along the center of the thickness of a second wall portion 38.

Each deformation-allowing wall portion 76 has, in plan view, an arc shape with its center at the virtual intersection P so that the arc shape connects the circumferentially opposing edges of a first wall portion 36 (a divided first wall portion 56) and a second wall portion 38. In Embodiment 1, each deformation-allowing wall portion 76 is formed in the aforementioned arc shape in plan view that extends over approximately the entire vertical length of the peripheral wall portion 34. In particular, in Embodiment 1, the arc shape of each deformation-allowing wall portion 76 is formed with an approximately constant curvature and a constant thickness dimension over the entire circumferential length thereof.

The deformation-allowing wall portions 76 circumferentially couple the first wall portions 36 (the divided first wall portions 56) and the second wall portions 38 together while maintaining the aforementioned shape. As such, the front second wall portion wall 38, with divided first wall portions 56 coupled to the lateral ends thereof, longitudinally opposes the rear second wall portion wall 38, with divided first wall portions 56 coupled to the lateral ends thereof, across a predetermined distance. One of the aforementioned elastic locking pieces 52 is provided between each pair of divided first wall portions 56 that longitudinally opposes each other. It should be noted that the thickness of the deformation-allowing wall portions 76 is not limited to any specific dimension; in Embodiment 1, the thickness dimension of the deformation-allowing wall portions 76 is approximately equal to that of the divided first wall portions 56 and the second wall portions 38. For example, the thicknesses of the wall portions remain approximately constant from the divided first wall portions 56 on the right, to the deformation-allowing wall portions 76 on the right, to the second wall portions 38, to the deformation-allowing wall portions 76 on the left, and to the divided first wall portions 56 on the left.

By coupling the first wall portions 36 to the second wall portions 38 with the deformation-allowing wall portions 76 shaped as described above, when a relay 20 is mounted to the relay mount 16, the pressure contact ribs 44 abut against the outer peripheral surface 88, which will be described below, of the relay 20, to elastically deform the first wall portions 36 and the second wall portions 38 in laterally outward and longitudinally outward directions. The elastic deformation of the first wall portions 36 and the second wall portions 38 in the laterally outward and longitudinally outward directions is allowed by the deformation of the deformation-allowing wall portions 76 formed in a curved and arc shape in plan view. In other words, the deformation-allowing wall portions 76 allow outward deformation of those of the first wall portions 36 and the second wall portions 38 provided with the pressure contact ribs 44 (both of the first wall portions 36 and the second wall portions 38 in Embodiment 1) when the pressure contact ribs 44 are pressed against the electrical component (a relay 20 or a resistor 22).

### Resistor Mount 18

As described above, the general shape of the resistor mount 18 is similar to that of the relay mount 16. In other words, the peripheral wall portion 34 of the resistor mount 18 also has first wall portions 36 and second wall portions 38 that extend in mutually intersecting directions, with a pair of first wall portions 36 laterally spaced apart from each other and a pair of second wall portions 38 longitudinally spaced apart from each other. In Embodiment 1, the first wall portions 36 and the second wall portions 38 extend in mutually orthogonal directions. In addition, a pair of slits 54 is provided in the longitudinally intermediate portion of each first wall portion 36 so as to be longitudinally spaced apart from each other, with the elastic locking piece 78 formed longitudinally between the slits 54 in the first wall portion 36.

It should be noted that the shape of each elastic locking piece 78 of the resistor mount 18 is different from that of the elastic locking piece 52 of each relay mount 16, and each elastic locking piece 78 has a vertical portion 80 that protrudes upward from the bottom plate portion 48 and is laterally elastically deformable, and a claw 82 that projects laterally inward from the upper end of the vertical portion 80. Moreover, as slits 54 and an elastic locking piece 78 are provided on each first wall portion 36, divided first wall portions 56 are formed on the longitudinal ends of the first wall portion 36. Additionally, pressure contact ribs 44 are formed only on the inner surfaces 42 of the second wall portions 38.

Likewise, in the resistor mount 18, the first wall portions 36 (the divided first wall portions 56) and the second wall portions 38 are circumferentially connected to each other via deformation-allowing wall portions 84. The deformation-allowing wall portions 84 of the resistor mount 18 each have a generally curved shape in plan view, and specifically, have the general shape of two arcs that are continuously and smoothly connected. More specifically, each deformation-allowing wall portion 84 swells out from the longitudinal end of the first wall portion 36 (the divided first wall portion 56) in an arc shape having a center angle of 180 degrees and is then connected to the second wall portion 38 via an arc shape having a center angle of 90 degrees at its circumferential end, and is connected to the lateral ends of the second wall portion 38 at points longitudinally inward of the apex of the deformation-allowing wall portion 84 (the longitudinally outer end).

### Electrical Components (Relays 20 and Resistor 22)

The relays 20 and the resistor 22 may include pre-charge relays and a pre-charge resistor, respectively. The relays 20 and the resistor 22 each have downward protruding terminals 86, and when the relays 20 and the resistor 22 are mounted to the relay mounts 16 and the resistor mount 18, respectively, the terminals 86 are inserted into the respective terminal insertion holes 29. In Embodiment 1, the shapes of the outer peripheral surface 88 of the relays 20 and the resistor 22 are approximately rectangular. Additionally, each relay 20 has provided on the lateral ends thereof a pair of locking claws 90 to engage with the elastic locking pieces 52 of the relay mount 16. Furthermore, as shown in FIG. 3, a positioning convex 92 is formed in a portion of the outer peripheral surface 88 of the relay 20, protruding outwardly from a circumferential location of the surface 88 that corresponds to the positioning recess 74 in the peripheral wall portion 34, and in Embodiment 1, the positioning convex 92 is formed on the left end of the relay 20. The positioning convex 92 may be provided, for example, at the lower end of the relay, and may have a predetermined vertical dimension.

### Assembly of Electrical Junction Box 10

An exemplary method of assembling the electrical junction box 10 will be described below. It should be noted that the method of assembly of the electrical junction box 10 is not limited to the aspect described below.

First, the relays 20 are mounted to the relay mounts 16 of the lower case 14. Specifically, each relay 20 is inserted through the upper opening 46 in a relay mount 16 and then pushed downward. Thereupon, the locking claws 90 provided on the lateral ends of the relay 20 abut against the elastic locking pieces 52 provided on the first wall portions 36 to elastically deform the elastic locking pieces 52 in the laterally outward directions. Then, the relay 20 is pushed further downward, causing the locking claws 90 to ride over the flexible tongues 66 into the engaging holes 64 until the locking claws 90 are engaged with the elastic locking pieces 52. As a result, the relay 20 is prevented from disengaging from the relay mount 16, thus mounting the relay 20 to the relay mount 16. With the relays 20 mounted in this way, the terminals 86 of the relays 20 are inserted in the terminal insertion holes 29 provided in the bottom wall portions 24 (terminal connecting portions 48) of the lower case 14.

The resistor 22 is mounted to the resistor mount 18 in a similar manner. The elastic locking pieces 78 are expanded laterally outward by inserting and pushing downward the resistor 22 through the upper opening 46 of the resistor mount 18. By causing the locking claws 82 on the elastic locking pieces 78 to ride over the upper ends of the resistor 22, the elastic locking pieces 78 elastically deform and restore the original shape thereof to be engaged with the upper surfaces of the resistor 22. As a result, the resistor 22 is mounted to the resistor mount 18, and the terminals (not shown) of the resistor 22 are inserted in the terminal insertion holes 29 provided in the bottom wall portions 24 (terminal connecting portions 48).

The electrical junction box 10 of Embodiment 1 is assembled by fitting an upper case (not shown) from above to the lower case 14, to which the relays 20 and the resistor 22 are mounted, and securing the lower case 14 to the upper case. By connecting the current-carrying members 12 including the relay terminals 30 and bus bars 32 to the terminals (e.g., the terminals 86) of the relays 20 and the resistor 22 protruding into terminal connecting portions 28 of the electrical junction box 10, the current-carrying members 12 are conductively connected with the relays 20 and the resistor 22.

According to the electrical junction box 10 of Embodiment 1 configured as described above, the inner surfaces 40, 42 of the first wall portions 36 and the second wall portions 38 of the peripheral wall portions 34 of the relay mounts 16 are provided with pressure contact ribs 44 so that the pressure contact ribs 44 are pressed against the outer peripheral surface 88 of the relay 20 when each relay 20 is mounted. If a relatively strong material is used as the material of relay mounts and if the first wall portions and the second wall portions are directly connected to each other, the first wall portions and the second wall portions might not easily deform so that the relay could be damaged by the pressure contact of the pressure contact ribs against the relay. In contrast, in the electrical junction box 10 of Embodiment 1, the first wall portions 36 and the second wall portions 38 are connected to each other by the deformation-allowing wall portions 76 that allow outward elastic deformation of these wall portions. When the relay 20 is mounted to the relay mount 16, the deformation-allowing wall portions 76 are deformed to expand, allowing the first wall portions 36 and the second wall portions 38 to deform elastically outward so as not to require excessively large insertion force and prevent damage to the relay 20. Moreover, as the first wall portions 36 and the second wall portions 38 deform elastically inward and restore the original shapes thereof so that the relay 20 can be stably held by the first and second wall portions 36 and 38.

In particular, since the first wall portions and the second wall portions are not independent of each other, but rather the first wall portions 36 and the second wall portions 38 are connected by the deformation-allowing wall portions 76, the outer peripheral surface 88 of the relay 20 is covered by the peripheral wall portion 34 all the way around, so that the relay 20 can be held stably by the relay mount 16. Although the first wall portions 36 and the second wall portions 38 are connected by the deformation-allowing wall portions 76, by allowing the deformation-allowing wall portions 76 to deform, the deformation of any of the first wall portions 36 and the second wall portions 38 does not affect the deformation of the others. In this way, the relays 20 and the resistor 22 can be stably mounted to the relay mount 16 and the resistor mount 18. The same effect is exerted in the resistor mount 18, so that the resistor mount 18 can stably hold the resistor 22.

In the relay mounts 16, pressure contact ribs 44 are provided on the inner surfaces 40 (68), 42 of the first wall portions 36 (the divided first wall portions 56) and the second wall portions 38, respectively. As such, the pressure contact ribs 44 are capable of holding the relay 20 on all the four sides of the relay mount 16 to enable stable holding of the relay 20.

In the relay mount 16, each deformation-allowing wall portion 76 is connected to the circumferentially opposing edges of a first wall portion 36 and a second wall portion 38, and has a shape that extends circumferentially around the virtual intersection P between the first wall portion 36 and the second wall portion 38. As such, as the deformation-allowing wall portions 76 are deformed to expand, the first wall portions 36 and the second wall portions 38 are allowed to elastically deform and expand outward. In particular, as the deformation-allowing wall portions 76 are formed in an arc shape in plan view, the first wall portions 36, the second wall portions 38, and the deformation-allowing wall portions 76 are capable of elastic deformation in a stable manner. Moreover, as the deformation-allowing wall portions 76 are formed in an arc shape in plan view, the deformation of the first and second wall portions 36 and 38 and the concurrent deformation of the deformation-allowing wall portions 76 can occur more stably compared to the case in which the first wall portions 36 and the second wall portions 38 are simply connected in straight lines.

### Embodiment 2

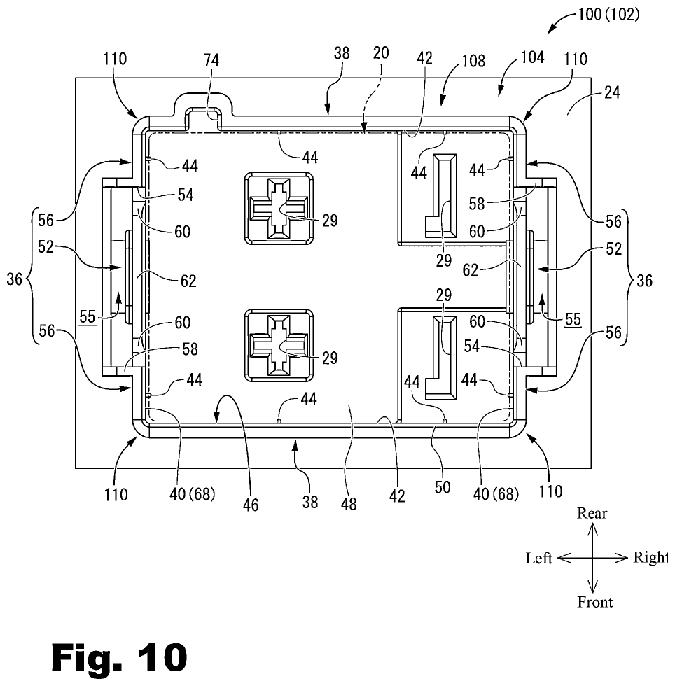

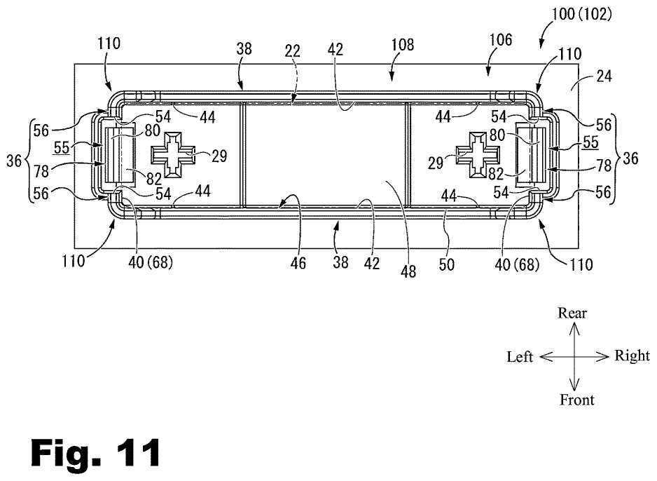

An electrical junction box 100 of an Embodiment 2 of the present disclosure will be described hereinafter with reference to FIGS. 10 and 11. Similar to Embodiment 1, the electrical junction box 100 is comprised of a lower case 102 and an upper case (not shown). FIG. 10 shows a relay mount 104 and the portions of the lower case 102 surrounding the relay mount 16 alone, and FIG. 11 shows the resistor mount 106 and the portions of the lower case 102 surrounding the resistor mount 18 alone. Embodiment 2 is identical to Embodiment 1 except that the relay mounts 104 and the resistor mount 106 are different from the relay mount 16 and the resistor mount 18 of Embodiment 1. Therefore, the structures of the relay mounts 104 and the resistor mount 106 will be described below, and the description of the other elements will be omitted. In the following description, members and parts that are substantially the same as those in Embodiment 1 will be omitted from detailed description by affixing the same symbols as those in Embodiment 1 in the drawings.

### Relay Mounts 104 and Resistor Mount 106

Also in Embodiment 2, the peripheral wall portions 108 of the relay mounts 104 and the resistor mount 106 each have a pair of first walls 36 laterally spaced apart from and facing each other and a pair of second walls 38 longitudinally spaced apart from and facing each other. The circumferentially opposing edges of the first wall portions 36 and the second wall portions 38 are connected to each other via deformation-allowing wall portions 110. Also in Embodiment 2, a pair of slits 54 is provided in the longitudinally intermediate portion of each first wall portion 36 of the relay mount 104, with an elastic locking piece 52 formed between the slits 54. In addition, a pair of slits 54 is provided in the longitudinally intermediate portion of each first wall portion 36 of the resistor mount 106, with an elastic locking piece 78 formed between the slits 54. Therefore, also in the relay mounts 104 and the resistor mount 106, the circumferentially opposing edges of the divided first wall portions 56 and the second wall portions 38 are connected to each other via the deformation-allowing wall portions 110.

### Deformation-Allowing Wall Portions 110

In Embodiment 2, the deformation-allowing wall portions 110 of the relay mounts 104 and the deformation-allowing wall portions 110 of the resistor mount 106 are formed in the same shape, and connect the circumferentially opposing edges of the first wall portions 36 and the second wall portions 38 via the arc-shaped portions thereof having a center angle of 90 degrees in plan view. The deformation-allowing wall portions 110 are formed of a material with greater flexibility (i.e., capable of greater flexibility) than that of the first wall portions 36 and the second wall portions 38. The material of the deformation-allowing wall portions 110 may be, for example, PBT without glass fibers, PBT with lower glass fiber content than the first wall portions 36 and the second wall portions 38, or other nylon-based synthetic resin material. The relay mounts 104 and the resistor mount 106, i.e., the lower case 102, may be formed by, for example, injection molding, such as two-color molding.

According to the relays 20 and the resistor 22 with the deformation-allowing wall portions 110, when the relays 20 and the resistor 22 are mounted, the first wall portions 36 and the second wall portions 38 elastically deform in the laterally outward and longitudinally outward directions. Concurrently, the deformation-allowing wall portions 110 elastically deform further circumferentially outward than the first wall portions 36 and the second wall portions 38. In this way, the peripheral wall portions 108 cover the entire peripheries of the relay mounts 104 and the resistor mount 106 without allowing the deformation of any of the first wall portions 36 and the second wall portions 38 to affect the deformation of the other wall portions. Therefore, the lower case 102 (the electrical junction box 100) of Embodiment 2, which includes the deformation-allowing wall portions 110, can also provide the same effect as in Embodiment 1.

### Variants

Having thus described Embodiments 1 and 2 in detail as a specific example of the present disclosure, the present disclosure is not limited to this specific description. Variations, improvements, etc. are included in the present disclosure to the extent that they can achieve the objects of the present disclosure. For example, the variations of the embodiment set forth below are included in the technical scope of the present disclosure.

(1) In the foregoing embodiments, the component mounts, such as the relay mounts 16 and 104 and the resistor mounts 18, 106, are formed on the lower cases 14 and 102, each of which constitute a resin case. However, the component mounts may be formed on the upper cases instead of, or in addition to, the lower cases.

(2) In the foregoing embodiments, an elastic locking piece 52 is formed in the longitudinal center portion of each relay mount 16 and 104. However, the present invention is not limited to this configuration. An elastic locking piece 52 may be provided on each second wall portion instead of, or in addition to, each first wall portion. In the above embodiments, although the elastic locking pieces 52 of the relay mounts 16 and 104 have a different shape from the elastic locking pieces 78 of the resistor mounts 18 and 106, these elastic locking pieces may also have the same shape. It should be noted that the elastic locking pieces are not essential for the relay mounts or the resistor mounts. In other words, each of the first wall portions of the relay mounts and the resistor mount may be formed as a single integral plate rather than being divided by slits.

(3) The foregoing embodiments describe the relays 20 and the resistor 22 as exemplary electrical components mounted to the component mounts (the relay mounts 16 and the resistor mount 18). However, the present invention is not so limited. Rather, any known electric component may be mounted as long as the peripheral walls of the component mount are formed in shapes that extend along the peripheral surfaces of the electric component. In the foregoing embodiments, the electrical components (the relays 20 and the resistor 22) have approximately rectangular shapes in plan view. However, the present invention is not limited to this; rather, the electrical components may have other polygonal shapes than rectangles. In that case, the peripheral walls of the component mounts may have shapes that extend along the peripheral surfaces of the electrical components, and the first wall portions and the second wall portions may intersect at any angle other than a right angle. Therefore, the present invention is not limited to the foregoing embodiments, in which a pair of first wall portions and a pair of second wall portions are provided to form the peripheral wall portion. Rather, it will suffice as long as any one of the plurality of wall portions that constitute the peripheral wall portion serves as a first wall portion and a wall portion circumferentially adjacent to the first wall portion serves as a second wall portion, pressure contact ribs are formed on the inner surface of at least one of the first wall portion and the second wall portion, and the first wall portion and the second wall portion are circumferentially coupled to each other via a deformation-allowing wall portion.

It will suffice if pressure contact ribs are formed on the inner surfaces of at least one of the first wall portions and the second wall portions, whether in the foregoing embodiments, in which the peripheral wall portions 34 and 108 have approximately rectangular shapes, or in the foregoing case, in which these wall portions have a shape other than a rectangle. Whether provided only on the first wall portions, only on the second wall portions, or on both first and second wall portions, the pressure contact ribs are preferably provided in longitudinally and/or laterally symmetrical positions.

(4) In the foregoing embodiments, the deformation-allowing wall portions 76 and 110 have approximately the same thickness dimension as the first wall portions 36 (the divided first wall portions 56) and the second wall portions 38, the present invention is not limited to this configuration. That is, the deformation-allowing wall portions may be thinner or slightly thicker than the first wall portions or the second wall portions.

(5) Embodiments 1 and 2 may also be used in combination. That is, if four deformation-allowing wall portions are provided as in the foregoing embodiments, at least one of the deformation-allowing wall portions may have the configuration of Embodiment 1 with the remaining deformation-allowing wall portions having the configuration of Embodiment 2. Alternatively, the configuration of the deformation-allowing wall portions of Embodiment 1 may be used for all the deformation-allowing wall portions while forming the deformation-allowing wall portions from a material having a greater flexibility than the first and second wall portions as in Embodiment 2. Furthermore, the deformation-allowing wall portions may also be formed thinner than the first wall portions and the second wall portions.

(6) In Embodiment 1, the deformation allowing wall portions 76 have an arc shape with its center at the virtual intersection P between the first wall portion 36 and the second wall portion 38 as shown in plan view. However, the present invention is not limited to this configuration. That is, the deformation-allowing wall portions may have a shape formed by, for example, a plurality of straight lines or by combination of straight and curved lines in plan view. Moreover, if the deformation-allowing wall portions are entirely or partially formed with curved lines in plan view, the curved lines may have a constant curvature or different curvatures in different parts thereof.

### LIST OF REFERENCE NUMERALS

10 Electrical Junction Box (Embodiment 1)
12 Current-Carrying Member
14 Lower Case (Resin Case)
16 Relay Mount (Component Mount)
18 Resistor Mount (Component Mount)
20 Relay (Electrical Component)
22 Resistor (Electrical Component)
24 Bottom Wall Portion
26 Lower Peripheral Wall Portion
28 Terminal Connecting Portion
29 Terminal Insertion Hole
30 Relay Terminal
32 Bus Bar
34 Peripheral Wall Portion
36 First Wall Portion
38 Second Wall Portion
40 Inner Surface (of First Wall Portion)
42 Inner Surface (of Second Wall Portion)
44 Pressure Contact Rib
46 Upper Opening
48 Bottom Plate Portion
50 Lead-In Surface
52 Elastic locking piece
54 Slit
55 Gap
56 Divided First Wall Portion
58 Separating Wall Portion
60 Vertical Portion
62 Connecting Portion
64 Engaging Hole
66 Flexible Tongue
68 Inner Surface (of Divided First Wall Portion)
70 Inclined Surface
72 Through-Hole
74 Positioning Recess
76 Deformation-Allowing Wall Portion
78 Elastic locking piece
80 Vertical Portion
82 Claw
84 Deformation-Allowing Wall Portion
86 Terminal
88 Outer Peripheral Surface
90 Locking Claw
92 Positioning Convex
100 Electrical Junction Box (Embodiment 2)
102 Lower Case
104 Relay Mount
106 Resistor Mount
108 Peripheral Wall Portion
110 Deformation-Allowing Wall Portion
P Intersection
L1 Straight Line (Extending Longitudinally along Center of Thickness of First Wall Portion (Divided First Wall Portion))
L2 Straight Line (Extending Longitudinally along Center of Thickness of Second Wall Portion)

What is claimed is:

1. An electrical junction box comprising:
a resin case; and
a component mount that protrudes from the resin case for mounting an electrical component;
wherein the component mount includes a peripheral wall portion extending along an outer peripheral surface of the electrical component,
the peripheral wall portion includes a first wall portion and a second wall portion disposed circumferentially adjacent to each other and extending in mutually intersecting directions,
pressure contact ribs are provided on an inner surface of at least one of the first wall portion and the second wall portion, the pressure contact ribs being pressed against the outer peripheral surface of the electrical component, and
the first wall portion and the second wall portion are circumferentially coupled to each other via a deformation-allowing wall portion, the deformation-allowing wall portion allowing outward deformation of whichever of the first wall portion and the second wall portion has the pressure contact ribs provided thereon when the pressure contact ribs are pressed against the electrical component.

2. The electrical junction box according to claim 1, wherein the pressure contact ribs are provided on the inner surfaces of the first wall portion and the second wall portion.

3. The electrical junction box according to claim 1, wherein the deformation-allowing wall portion is connected to circumferentially opposing edges of the first wall portion and the second wall portion, and has a shape that extends circumferentially around a virtual intersection between the first wall portion and the second wall portion.

4. The electrical junction box according to claim 3, wherein the deformation-allowing wall portion has an arc shape with a center thereof at the virtual intersection between the first wall portion and the second wall portion, the arc shape connecting the circumferentially opposing edges of the first wall portion and the second wall portion.

5. The electrical junction box according to claim 1, wherein the deformation-allowing wall portion has a curved shape connecting circumferentially opposing edges of the first wall portion and the second wall portion.

6. The electrical junction box according to claim 1, wherein the deformation-allowing wall portion is formed of a material with greater flexibility than that of the first wall portion and the second wall portion.
